(19) United States
(12) Patent Application Publication
(10) Pub. No.: US 2007/0171898 A1
(43) Pub. Date: Jul. 26, 2007

(54) SYSTEM AND METHOD FOR ESTABLISHING UNIVERSAL REAL TIME PROTOCOL BRIDGING

(76) Inventor: Paul D. Salva, Pleasant Prairie, WI (US)

Correspondence Address: PATZIK, FRANK & SAMOTNY LTD., 150 SOUTH WACKER DRIVE, SUITE 1500, CHICAGO, IL, 60606, US

(21) Appl. No.: 11/563,705

(22) Filed: Nov. 28, 2006

Related U.S. Application Data
(60) Provisional application No. 60/740,491, filed on Nov. 29, 2005.

(51) Int. Cl. H04L 12/66

(52) U.S. Cl. 370/356

(57) ABSTRACT

An apparatus and methods for Real Time Protocol (RTP) based bridging to create calls to and From any communication devices connected to the Public Switched Telephone Network (PSTN) or any public or private Internet Protocol network. The methods are represented in controls residing either in an RTP Bridge apparatus or as middleware on a service creation platform, softswitch, or SIP proxy services incorporating SIP bridging and SIP call relay technologies, with an interface to a TDM (Time Division Multiplexing) switch operated by a Local Exchange Carrier (LEC) or Competitive LEC (CLEC), or hosted by an Internet Telephony Service Provider (ITSP) with connectivity to the PSTN through media gateways. The method permits a party to request an on demand conference call by either dialing into the apparatus from the PSTN or from any type of RTP communication device such as an IP phone; or using a form of signaling from RTP translation device. The moderator initiates the request, enters the participant(s) to be included in the call, and the launch sequence is initiated and the apparatus makes contact with the phone/end point and uses RTP bridging to interlace the packet streams and deliver one stream back to all the devices. The advantage is an on demand conference call to one or many participants, on similar or different communications platforms.

### CROSS-REFERENCE TO RELATE APPLICATIONS

This application claims priority to U.S. provisional patent application Ser. No. 60/740,491 fled on Nov. 29, 2005.

### BACKGROUND OF THE INVENTION

1. Field of the Invention

The present invention relates, in general to telecommunications, and, in particular, to communications amongst devices connected to Public Switched Telephone Networks (PSTNs) and any public or private Internet Protocol network.

2. Description of Related Art

In the global marketplace and with people having friends and relatives across the United States and the world, there is an ever increasing demand to develop and improve the methods and ways people communicate with one another. One recent development has been Voice over Internet Protocol (VoIP) or Internet Protocol (IP) telephony. While certain companies currently offer IP telephony, IP telephony is susceptible to a host of security challenges. These challenges are detailed in a document titled “VoIP Security and Privacy Threat Taxonomy” released Oct. 24th, 2005 by the VOIPSA, the Voice Over Internet Protocol Security Alliance. The VOIPSA is an open, vendor-neutral organization, made up of VoIP and information security companies, organizations, and individuals that have a desire to participate in project releases, strategy and other decisions.

As outlined by the VOIPSA organization, IP telephony is susceptible to privacy and security attacks such as:
1. Misrepresentation—misrepresenting identity, misrepresenting authority or authorizations, misrepresenting rights or content such as impersonation of the voice of a caller, the words of a caller, printed words, still images or video or any modifications of spoken, written or visual content With the intent to mislead.
2. Theft of services—such as the unauthorized deletion or altering of billing records, the bypass of lawful billing systems, unauthorized billing, taking of service provider property.
3. Unwanted contact—any contact that either requires prior consent or bypasses a refusal of consent, including harassment, extortion, unwanted lawful content—including spam and other offensive content
4. Eavesdropping—an attack or method of monitoring the entire signaling or data stream between two or more VoIP endpoints, but cannot or does not alter the data itself. This includes call pattern tracking, traffic capture, number harvesting, conversation reconstruction, voicemail reconstruction, fax reconstruction, video reconstruction, and text reconstruction.
5. Interception and modification, which is described as a method by which an attacker can see the entire signaling and data stream between two endpoints, and can also modify the traffic as an intermediary in the conversation—this includes “Black Holing” an unauthorized process of dropping, absorbing or refusing to pass IP or other VoIP protocols, call rerouting, fax alteration conversation alteration, conversation degrading, conversation impersonation and hijacking, false caller identification.
6. Service abuse—the improper use of services such as call conference abuse, premium rate service fraud, improper bypass or adjustment to billing, identity theft, registration attacks and misconfiguration of endpoints.
7. Intentional interruption of service—specific denial of service attacks (DoS), general denial of service attacks, physical intrusion or attacks on the physical locations of Internet VoIP servers, resource exhaustion which are interruptions of service because of an interruption of power supplies, performance latency caused intentionally due to Such known attacks as request flooding, user call flooding, user call flooding overflowing to other devices, endpoint request flooding, endpoint request flooding after call setup, call controller flooding, request looping, directory service flooding, disabling endpoints with valid requests, injecting invalid media into call processor, malformed protocol messages, spoofed messages, faked call teardown messages, faked response, call hijacking, registrations hijacking, media session hijacking, server masquerading and other distributed denial of service attack.

In addition to the security issues faced by VoIP technologies, VoIP technologies can also suffer from poor voice quality or service due to Internet congestion or poorly managed private networks. Packet delay or latency, the time it takes for the voice of one caller to be reached by the other caller; packet loss, the loss of digital information in the packet stream; and jitter, the affect of voice packets arriving out of sequence can all contribute to poor voice quality, message loss and user frustration.

Other contributing factors to the overall performance of VoIP telephony are that many VoIP providers are new to the telephony market and their software is sometimes less robust and reliable than traditional phone systems. Additionally, some VoIP systems have computer and phone interfaces that are too complicated for the average user, which can also result in user frustration.

Session Initiation Protocol (SIP) adoption is increasing steadily and many solution providers are looking to leverage the power and capabilities, such has third party call control, that SIP can bring—more efficient use of communications hardware and software being a key driver.

Third party call control refers to the ability for an entity, such as an IP Phone, to create and manage a call in which the media actually flows between other entities. SIP facilitates this through its separation of signaling and media; the signaling Can be managed by one device while the media is handled by another device. Traditionally, media resource card vendors have assumed that the media and signaling will both be terminated in the same place as is the case for Time Division Multiplexing (TDM) calls, and created products accordingly.

SIP Bridging makes it possible to use a SIP protocol stack in a much more powerful manner. SIP Bridging breaks the assumption that the media and signaling will both be terminated in the same place, allowing developers to build back-to-back user agents and third party call control products. With SIP Bridge technology, the number of signaling channels available is unrestricted.

This alternative method offers a fragmented set of functions focused toward one application only, whereas this invention is a unique collection of methods used in new ways offering the ultimate flexibility to developers who can select the functions required to scale a wide range of low to high density applications. It is a highly configurable system that combines IP telephony and TDM digital network bridging functions and offers universal Real Time Protocol (RTP) bridging methods.

This invention sets out to provision RTP-based conference calling services involving both toll switching systems and RTP based voice and video streams, in particular, to a system and a method for establishing conference bridging between a calling party having access to an IP based communications device or a phone connected to the public switched telephone network (PSTN) and multiple called parties also having access to either a PSTN or RIP based devices.

The rapid growth and adoption of SIP and its ubiquitous availability in the known world having given rise to new opportunities for facilitating voice and video communications which include the use of various capabilities of private and public IP networks with connectivity to the PSTN.

The practical problem with existing conferencing solutions is the high cost to own and operate audio conferencing bridges or MCUs as well as the scheduling and manner of executing a conferencing call. RTP bridging enables the capability for a SIP device to launch the calls automatically without operator intervention. (Consequently, it is desirable to provide a system which is capable of placing a SIP call for the operator, from the most desirable point of the network which is the edge, or last mile.

Because of SIP bridging, it is now possible to create unique applications and the automation of what once were manual processes of conference calling. This allows an end user to access remote resources and to launch call control from a central location.

There is a need, therefore, to provide RTP-based bridging with options of generating calls automatically and translating RTP streams so that any phone or other devices can call any communications device located on any network, while being economical and easy to manufacture and use.

### SUMMARY OF THE INVENTION

The method and the apparatus in accordance with this invention provide a novel means of establishing RTP or SIP Conferencing between calling parties on dissimilar communications devices and networks. For the purposes of the description which follows, “connected to the PSTN” means any telephone set to which a call may be placed to or from the PSTN, including cellular telephones, radio telephones, ship-to-shore telephones and any other voice communications device which is accessible through the PSTN, including a PBX, fax machine, teletype, or other special accessibility equipment.

It will also be understood by those knowledgeable in the art of conference bridging that the provider MCU and the call connection, having an interface to the PSTN, are different machines which are geographically co-located or geographically separated.

It is an objective of the present invention to provide subscribers with phones connected to the PSTN with on demand conference calling which permits the subscriber to initiate a conference call which can be set up on demand, and initiated from a universal RTP Bridge to any type of phone connected to any network.

It is a further objective of the invention to provide subscribers with the ability to connect to other communications devices, particularly SIP phones, whereby the selection of destination devices is based on the RTP streams, with or without access to the PSTN.

It is yet another objective of the invention to provide subscribers with the capability to include one-way translation devices to the call for recording or having, among other things, speech to text be displayed across a text viewing device or as a RTP stream along with a video stream for video conferencing or webcasting.

The first aspect of the invention provides a method of establishing voice communications between a RTP bridge by a calling party having access to a telephone, RTP device, or other intelligent communication device which has path to the RTP bridge, that requests a call set-up with other telephones, RTP devices or other intelligent communication devices accessible from the RTP Bridge. The RTP Bridge establishes the connections to the called parties and interlaces the streams, comprising the steps of:
A) receiving a request from the calling party and sending call request packets to an end point such as, but not limited to, SIP phones or VoIP gateways with access to the PSTN;
B) instructing the RTP Bridge to establish a connection with the destination devices; and
C) interlacing the RTP streams together to complete the conference call.

A further aspect of the invention is the provision for establishing communications between an origination telephone or SIP phone by a calling party and terminating calls to multiple devices, comprising the following:

A function of the present invention is to serve as a bridge and entry point for calls coming from an Internet Telephony Service Provider (ITSP) (or a Competitive Local Exchange Carrier (CLEC)), being authenticated and then being delivered back to the PSTN through an ITSP. The various functions described below are likewise performed by the present invention.
Authentication based on calling number. The calling number will always be passed to an external Remote Authentication Dial In User Service (RADIUS) server for authentication.
Multiple multilevel IVR-custom IVR scripts will be written to define IVRs for incoming calls.
HTTP interface—a simple http interface will be available to allow users to:
1. browse to the URL of the RTP Bridge
2. log-in to the system (username and password authentication)
3. type-in their phone number, and up to (n) other participants
4. click “Call” button to make the call
Wireless Application Protocol (WAP) interface development as required for the WAP initiated call feature as outlined herein.
Dial through will allow a user to use 2 stage dialing to make SIP conference calls.
Dial-back will allow a user to call into a predefined number and receive a call back and request an on demand conference call.
Calling number is always passed through the RTP Bridge to the destination party by extracting the origination and termination numbers from the call request packet and forwards an encrypted packet to the media gateway which decrypts the packet and uses the origination and termination numbers to instruct the toll switch to set up the call.

The method in accordance with the invention permits any voice communications device to establish a call or conference call with other devices either connected to the PSTN or to any IP network which the called party is connected. The method is also adapted for the provision of one way calls receiving a stream of the conference for recording or translation purposes.

The system in accordance with the invention may be described as “Universal RTP Bridging” which preferably establishes a call or conference call between several devices, but may be between 2 end points. The benefits of the URTP (Universal Real Time Protocol) Bridge are the elimination of intelligent edge devices (customer premises equipment), broadband connectivity, and the quality and security concerns associated with both. Among other things Universal RTP (URTP) does not require customers to have special broadband connections to specific hardware and software applications, does not require special phones, phone stations or equipment with specific IP or WiFi functionality. URTP Bridging allows all of the unique benefits that a Voice over Internet Protocol phone service provides, including the cost savings, without the performance or security concerns that IP telephony is currently challenged with. URTP is truly universal as it will accept all forms, services or brands of existing wireline, wireless, cellular or WiFi telecommunications.

The present invention comprises an apparatus for establishing RTP based bridging where calls are originated from the bridge device to telephones connected to the PSTN or an IP network, where the calls are interlaced and two-way audio is established to all phones on either transport. The is accessible by the calling party's Time Division Multiplexing (TDM) phone, from an intelligent communications device, or from an alternative SIP signaling device, where the apparatus is pre-programmed to:

a) on a per call basis authenticate the caller by Automatic Number Identification (ANI) i.e., caller ID, PIN number via IVR touch tone, voice biometrics, IP address, or other signaling protocol and records this information for later identification;

b) request the number(s) or address(es) to be dialed, or presents a pre-programmed list to choose from;

c) place call(s) to a local PSTN telephone number via SIP-PSTN proxy services, IP-PSTN, directly to a SIP telephone number, or to send RTP packets to a communications device for recording or converting to other media type. Examples of RTP streams include video codecs such as H.323, audio codecs such as (G.711, MP3, MPEG; etc. Virtually any communications media that requires time sensitive delivery. RTP is defined by IETF, Internet Engineering Task Force, a large open international community organization of network designers, operators, vendors, and researchers concerned with the evolution of the Internet architecture and the smooth operation of the Internet. (http://www.ietf.org) in RFC 3550.

The RTP Bridge of the present invention is also capable of translating touch tone signals for IVR, web server HTTP browsers from PCs, WAP from Internet cell phones, and receiving a launch sequence from other signaling devices—including, but not limited to Voice over IP (VoIP). Moreover, the RTP bridging, authentication, and pre-programmed launch sequence instructions may all be done by the same machine, such as an appliance.

The applications of the present invention may reside on a SIP Bridge, softswitch or SIP Proxy Server, or as middleware on a service creation platform, with control functions residing on a separate machine from the high density telco switch or Media Gateway ports.

The present invention also comprises a method of establishing a dial-back call which allows a moderator to dial into a predefined number that terminates to the apparatus, where the apparatus will take the steps of:

a) recording the ANI, SIP number, IP address, or other signaling device, and authenticating the calling number against a registration database;

b) dialing the calling party back and providing audible instructions or graphical or text options, based on registration information, to enter (n) number of participants into the conference call;

c) having the apparatus determine the type of communications protocol to use for the requested parties and establishing a connection in its native form where the bridging function translates the protocol using software codecs or hardware MCUs into a common RTP stream; and

d) having the apparatus pass through the ANI or a conference call reference number as an indication to the called party to recognize the incoming request.

The moderator is assumed to be the calling party, and the most secure authentication is established by dialing back the recorded number or address as well as an alternative number or address giving the true moderator the chance to terminate the conference listen in on mute, record the call, or treat the call accordingly.

The present invention also comprises a method of extending the access to a universal RTP bridge via establishing dial-through call allowing a PSTN customer to benefit from the economies of scale associated with VoIP without the need for a local broadband connection or adapter equipment. Herein the moderator dials a predefined local or toll free number, or a hot line is provisioned from said phone company, that terminates to the apparatus where the apparatus will take the steps of:

a) on a per call basis, authenticating the caller by ANI, PIN number, or voice biometrics and records this information for later identification;

b) providing audible options, based on what is authorized within the registration information, to enter (n) number of participants into the call;

c) dialing up each number and passing through the ANI as Caller ID information, or providing a conference call reference number as an indication to the called party; or is programmed to provide no information at all; and

d) bridging all the calls to perform the conference until the calls are self-terminated or a predetermined limit is set for the duration of the call.

The present invention also comprises a method of establishing WAP initiated calls allowing a moderator to web into the apparatus comprising the steps of:

a) providing authentication options including either manual password or automatic based on known IP addresses of intelligent device authenticating the caller against a registration database;

b) having the moderator enter in the destination number(s) of participant(s) into the call list and clicks to call the entire list—with an option to drop or mute a call in the event that a called party's voicemail answers or there is background noise and the other parties of the call wish to remain in the call;

c) having the RTP Bridge apparatus dial up each number and passes through the ANI as Caller ID information, or provides a conference call reference number as an indication to the called party; or is programmed to provide no information at all; and

d) having the apparatus then bridge all the calls to perform the conference until the calls are self-terminated or a predetermined limit is set for the duration of the call or are dropped from the moderator's options programmed in the WAP GUI.

The present invention also comprises a method of allowing PSTN calls from any phone to reach RTP communication devices that are not already registered to a gateway provider, wherein the apparatus launches a preconfigured set of execution steps to place calls to said devices, and wherein, prior to the launch sequence the caller would have pre-programmed in the destination number or address into a call list prior to the call from a web interface, IVR, or voice activation system and is either assigned a private pin number or a phone number to dial, the method comprising the steps of:

a) having the caller initiate launch sequence though various methods;

b) having the apparatus place calls based on the pre-programmed information;

c) having the apparatus use the appropriate network peering to reach the destination number or address and bridges the call(s); and

d) having the apparatus then uses RTP bridging to perform the conference call until the calls are self-terminated or a predetermined limit is set for the duration of the call.

The present invention also comprises a method of signaling from any RTP device connected to the apparatus wherein the apparatus launches a preconfigured set of execution steps to place pre-programmed calls. Examples of signaling methods would be the ability to reach a specific IP address from all intelligent device, or using a SIP signal from a push-to-talk device on a cell phone to send a launch sequence to the apparatus. Wherein, prior to the launch sequence the caller would have pre-programmed in the destination number or address into a call list prior to the call from a web interface, IVR, or voice activation system and is either assigned a private pin number or a phone number to dial or IP address to ping, where the method comprises the steps of:

a) having the caller initiate launch sequence though various methods;

b) having the apparatus place calls based on the pre-programmed information; and

c) having the apparatus then bridge all the calls to perform the conference call until the calls are self-terminated or a predetermined limit is set for the duration of the call.

The present invention also comprises a method of capturing, storing and replicating an RTP streams wherein the apparatus has the ability to record and playback encoded media files or voice/video codes for use in the following applications:

a) recording audio/video

b) duplicating audio/video for broadcast or multicast distribution

c) playing back recorded audio/video

The present invention also comprises a method of signaling the apparatus to capture and stream on demand for use in simulating a push-to-talk or walkie talkie operation from any communications device or computer with access to an IP network.

The present invention also comprises a method of using a Ring Down Circuit to signal the apparatus where the apparatus drops the call and initiates a call back to the originating phone, thus eliminating the step of dialing the apparatus.

The present invention also comprises a method of using a multicast tunnel and/or encryption technology to create a per-to-peer connection to allow secure point-to-point or group collaboration. The application would be for private voice, video, or data communications managed by the apparatus, in conjunction with the other methods described above.

It is yet another object of the present invention to produce a system and method for establishing URTP Bridging that is economical and easy to manufacture and use.

Other objects, features and advantages of the invention will be apparent from the following detailed disclosure, taken in conjunction with the accompanying sheets of drawings, wherein like reference numerals refer to like parts.

### BRIEF DESCRIPTION OF THE SEVERAL VIEWS OF THE DRAWINGS

FIG. 1 is a schematic diagram illustrating dial through on demand conferencing using RIP bridging in accordance with the present invention;

FIG. 2 is a schematic diagram illustrating dial-back on demand conferencing using RTP bridging in accordance with the present invention;

FIG. 3 is a schematic diagram illustrating WAP initiated conferencing using RTP bridging in accordance with the present invention;

FIG. 4 is a process flow diagram illustrating dial through on demand conferencing using RTP bridging in accordance with the present invention;

FIG. 5 is a process flow diagram illustrating dial-back on demand conferencing using RTP bridging in accordance with the present invention;

FIG. 6 is a process flow diagram illustrating WAP initiated conferencing using RTP bridging in accordance with the present invention;

FIG. 7 is a process flow diagram illustrating conferencing using RTP bridging in conjunction with pre-programmed instructions specified by a user in accordance with the present invention;

FIG. 8 is a process flow diagram illustrating conferencing using SIP bridging in conjunction with pre-programmed instructions specified by a user in accordance with the present invention;

FIG. 9 is another process flow diagram illustrating conferencing using SIP bridging in conjunction with pre-programmed instructions specified by a user in accordance with the present invention;

FIG. 10 is a process flow diagram illustrating conferencing initiated using SIP signaling in conjunction with pre-programmed instructions specified by a user in accordance with the present invention; and

FIG. 11 is a process flow diagram illustrating the bridging of SIP based text-to-speech, recording, multicasting, or streaming device into a call in accordance with the present invention.

### DETAILED DESCRIPTION OF THE INVENTION

While this invention is susceptible of embodiment in many different forms, there is shown in the drawings and will herein be described in detail several specific embodiments, with the understanding that the present disclosure is to be considered merely an exemplification of the principles of the invention and the application is limited only to the appended claims.

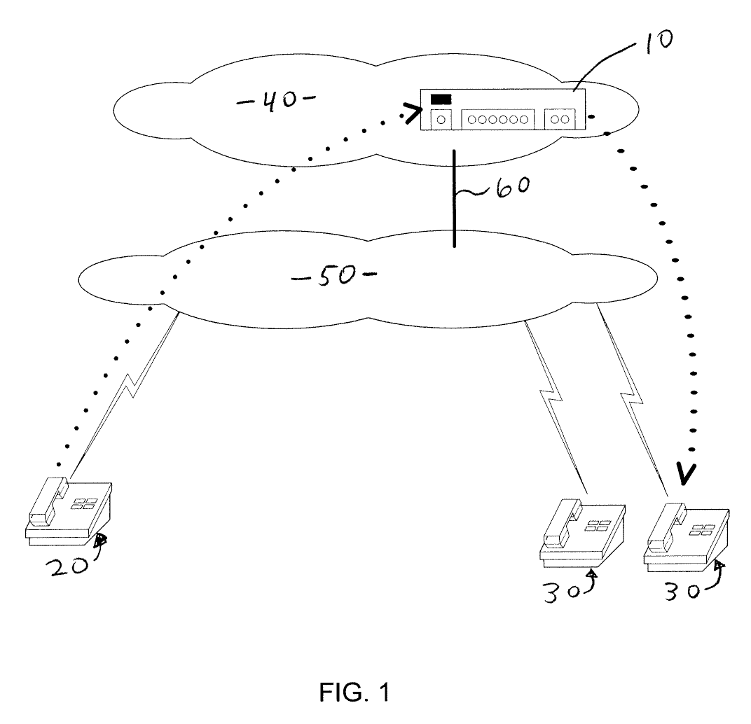

FIG. 1 is a schematic diagram illustrating an arrangement of the apparatus in accordance with the invention which outlines a Dial Through on demand conferencing application where the user dials a local, long distance, or toll-free number that connects to the RTP bridge, or from a SIP phone the user may reach the RTP bridge directly. As shown in FIG. 1, RTP Bridge 10 is hosted by an ITSP or CLEC 40. The ITSP/(CLEC is connected to a local PSTN 50 via communication network 60. Both the calling party's telephone 20 and called party telephones 30 are likewise connected to local PSTN 50. RTP Bridge 10 authenticates the calling party 20 via Automatic Number Identification (ANI). Next, RTP Bridge 10 issues a voice prompt to the calling party 20, such as “please enter destination numbers followed by a #−when done press*”. Calling party 20 then dials one or more destination numbers, and RTP Bridge 10 calls the identified called parties 30 through ITSP/CLEC 40, network 60, and local PSTN 50, passing the calling partie's ANI as Caller ID. This results in connections terminating to the called numbers 30 as RTP Bridge 10 interlaces the packet streams. As shown in FIG. 1, the user dials a direct inward dial (DID) number which can be a toll free, local or long distance number provided to reach the RTP Bridge. The RTP Bridge authenticates the calling party and returns a voice prompt to the user letting them know “Now you can make a call”.

The user then dials the destination number and the RTP Bridge places the calls automatically on demand, wherein the calls are eventually terminated to either phones on the PSTN or other RTP communication devices such as, but not limited to, a SIP phone.

Authentication Comprises Four Steps:

In the first step, the RTP Bridge authenticates the user based on caller ID and the local authentication table stored on the RTP Bridge. The local authentication table is configurable from WEB GUI of the RTP Bridge. If the match is not found in the local table and the RADIUS support is enabled then the authentication procedure goes to the next step. Otherwise, if the match is found, the RTP Bridge finishes authentication and connects the calls;

In the second step, the RTP Bridge connects to the RADIUS server for caller ID authentication. If the match is not found in the RADIUS database, then the authentication procedure goes to the next step. Otherwise, if the match is found, the RTP Bridge finishes authentication and connects the calls;

In the third step, the RTP Bridge authenticates the user based on the user ID and password entered by the user on the RTP Bridge's voice prompt (“please enter your user name”; “please enter your password”). The RTP Bridge collects the digits entered by user and looks for a match in the local authentication table stored on the RTP Bridge. If the match is not found and the RADIUS support is enabled, the authentication procedure goes to the next step. Otherwise, if the match is found, the RTP Bridge finishes authentication and connects the calls. If the match is not found and the RADIUS support is disabled, the authentication procedure stops, and the RTP Bridge sends the voice prompt to the user (“you are not allowed to do the call”) and disconnects the call.

In the fourth step, the RTP Bridge connects to the RADIUS server for the user ID and password authentication. If the match is not found in the RADIUS database, then the authentication procedure stops, and the RTP Bridge sends the voice prompt to the user (“you are not allowed to do the call”) and disconnects the call. Otherwise, if the match is found, the RTP Bridge connects the call.

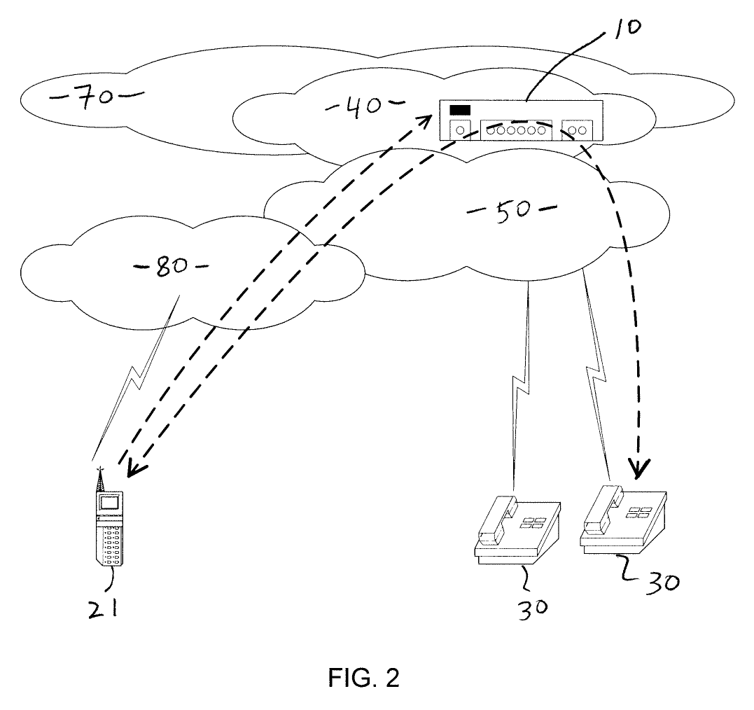

FIG. 2 is a schematic diagram illustrating an arrangement of the apparatus in accordance with the invention which outlines a Dial-Back on demand conferencing application where the feature will allow a user to call into a predefined number that terminates to the RTP Bridge. RTP Bridge 10 is again shown hosted by ITSP/CLEC 40 which, in turn, is connected to the overall internet 70, as well as local PSTN 50 which, in turn, is connected to cellular network 80. Mobile phone 21 dials a local number to reach RTP Bridge 10 via cellular network 80, local PSTN 50 and ITSP/CLEC 30. The RTP Bridge will not answer the call, but instead will take note of the calling number and drop the call, typically with no fee assigned to the call by the wireless/cellular network provider. The KTP Bridge will then authenticate/authorize the calling number using ANI for subscription purposes. If the calling number is valid, the RTP Bridge will then initiate a VoIP call back to mobile phone 21 for security and authentication purposes. Once the user answers, the user will be presented with a voice prompt, such as: “please enter destination numbers followed by a #−when done press*”. The mobile phone user then dials the destination numbers and RTP Bridge 10 makes the VoIP calls to the identified called parties 30 through ITSP/CLEC 40, eventually terminating to the called PSTN number and bridges the calls. RTP Bridge again passes through the ANI of the mobile phone as caller ID. As shown in FIG. 2, the dial-back feature will allow a user to call into a predefined number to reach the RTP Bridge. The RTP Bridge will not answer the call, but instead will take note of the calling number or address. After 1 ring, the user can terminate the call or the RTP Bridge will drop the call automatically. The RTP Bridge will then authenticate the calling number based on caller ID and the local authentication table stored on the RADIUS server. The local authentication table is configurable from a world wide web GUI interface, and may be configured by an authenticated user over any web browser connected to RTP Bridge 10 via internet 70 and ITSP/CLEC 40.

If the match is found in the authentication table, the RTP Bridge will then initiate a call back to the user. Once the user answers, the user will be presented with a voice prompt that states, “Now you can make a call”. On that voice prompt, the user dials the destination numbers and the RTP Bridge connects the calls as an on demand conference.

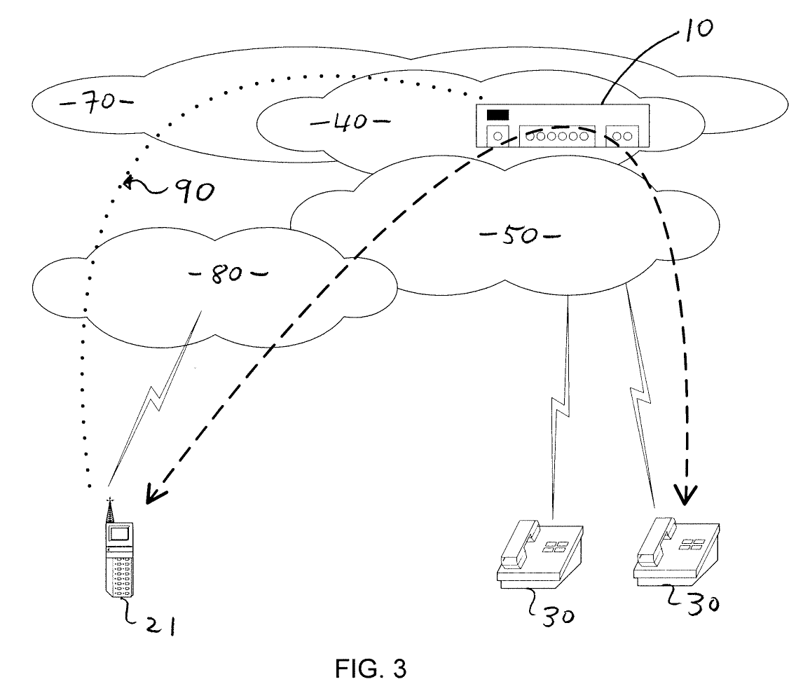

FIG. 3 is a schematic diagram illustrating an arrangement of the apparatus in accordance with the invention which outlines WAP initiated calls in accordance with the following steps. FIG. 3 is similar to FIG. 2, with the addition of WAP connection 90 between calling mobile phone 21 and RTP Bridge 10.

In the first step, the calling party browses to the Uniform Resource Locator (URL) of RTP Bridge 10 using WAP 90 enabled cell phone 21. Alternatively, a Personal Digital Assistant (PDA) device with WiFi: (wireless local area network) access may be employed in place of a WAP enabled mobile telephone. In the second step, authentication options should include either manual or automatic based on known IP addresses of PDA devices or dial-back to PSTN number. In the third step, once authenticated, RTP Bridge 10 is aware of the phone number of the PDA as it should be contained in a database that correlates this information with the known IP address anti authentication information. In the fifth step, the mobile telephone or PDA user can enter multiple phone numbers in the simple WAP GUI screen of their PDA. In the sixth step, the user clicks a “Call” button to make the calls out to scheduled users as well as on demand to the numbers listed by the user at that time. In the seventh step, included is a drop button to drop parties if their voicemail answers and the other parties of the call wish to remain in the call.

As shown in FIG. 3, a simple WAP/HTTP interface 90 allows users to browse to the URL of RTP Bridge 10 using their WAP or HTTP enabled mobile telephone, “smart phone” or PDA device. Authentication options include either manual or automatic authentication. In case of manual configuration, the user needs to enter explicitly the authentication user name and password from the WAP or HTTP GUI. The automatic authentication is based on the user name and password configured on the RTP Bridge and saved on the PDA device (user name and password saving depends on PDA device capabilities).

Once authenticated, the RTP Bridge extracts the phone number of the PDA from the RTP Bridge's local database that correlates this information with the user name and password. Local database is configurable from GUI. The user can enter from one to several phone numbers in the simple WAP or HTTP GUI screen of their PDA. Note: the phone numbers could be SIP Phone numbers.

Click a “Call” button or a “Call” menu item to make the call back to the user as well as to the numbers listed by the user on PDA GUI. Included is a drop button to drop parties if their voicemail answers and the other parties of the call wish to remain in the call.

When the user presses the “Call” button, the RTP Bridge makes a call to the phone number assigned to the PDA device which may have a softphone loaded or have cell phone capabilities. Next, the RTP Bridge calls the first number in the PDA list. When that number answers, the call is being connected to the PDA user. If the call goes to voicemail, the PDA user can hear the voice prompt and drop that user (either before or after leaving some voice mail). To drop the call, the user may either to push the “Drop” button or menu item. To dial the next number from the list, the PDA user presses the “Next” button or menu item. The procedure stops as soon as all users listed in PDA GUI are connected to the call or are dropped by the PDA user. If the PDA user who initiated the call terminated by call drop or intentional hangs up, all the calls to other parties may remain on the line. Additionally, if some of the called users terminate the call, then the other users will also still remain on the call.

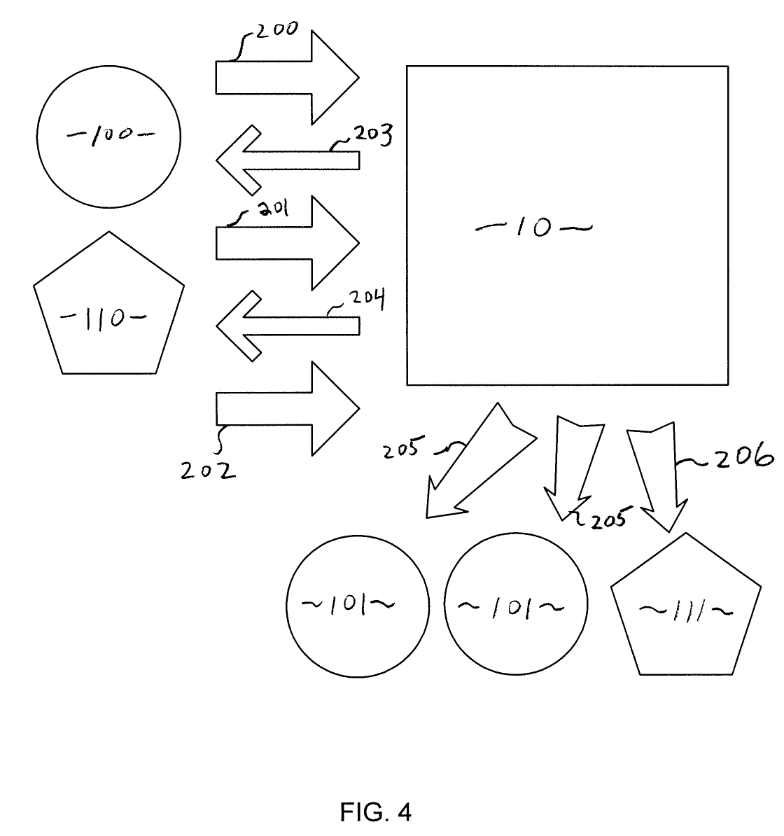

Process flow diagrams for the various method of the present invention are shown in FIGS. 4-7. In dial through mode, as shown in FIG. 4, RTP Bridge 10 is accessible by the calling party's analog, phone 100 or SIP phone 110 which may comprise, for example, a Time Division Multiplaxing (TDM) phone, an intelligent communications device, or from a alternative signaling device. The calling phone sends the RTP Bridge its ANI 200 or PIN 201 and SIP signal 202 (depending upon whether an analog or SIP calling phone is employed). In response, RTP Bridge 10 is pre-programmed to issue a request 203 for a called party's telephone number, or to present choices 204 in the form of text or audible tones. Next, RTP Bridge 10 bridges calls to analog called phones 101 and/or SIP called phones 111 by placing one or more calls (depending upon the number of telephone numbers to be called that has been entered by the user) to a local PSTN telephone number via SIP-PSTN proxy services 205, IP-PSTN, directly 206 to a SIP telephone number, or by sending RTP packets to a communications device for recording or converting to other media type and bridges (conferences) in all call types.

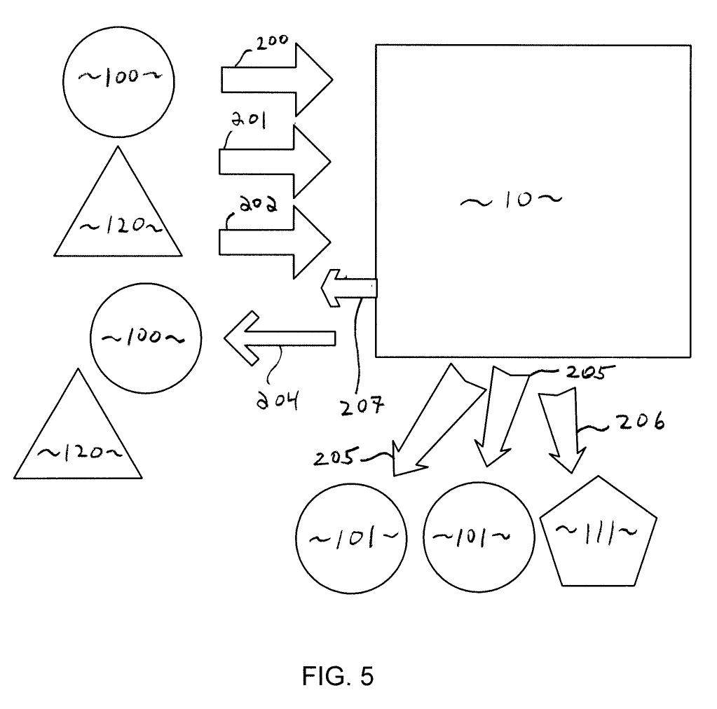

In dial-back mode, as shown in FIG. 5, RTP Bridge 10 is accessible by receiving an ANI 200, PIN 201, or SIP signal 202 from the calling party's Time Division Multiplaxing (TDM) analog phone, from an intelligent communications device, or from a alternative signaling device 120. In this embodiment, RTP Bridge 10 is pre-programmed to retrieve the caller ID or address of communications device and disconnect the call 207. Next, RTP Bridge 10 issues requests 204 for the recipient telephone numbers or device addresses, or presents choices to the caller in the form of text or audible tones. RTP Bridge 10 then dials back the original caller, places call(s) to a local PSTN telephone number via SIP-PSTN proxy services 205, IP-PSTN, directly 206 to a SIP telephone number, or to send RTP packets to a communications device for recording or converting to other media type, and interlaces the calls for an on demand SIP Bridge conference call. In this embodiment, while the moderator of the conference is assumed to be the calling party, the most secure authentication is established by dialing back the recorded number or address as well as an alternative number or address giving the true moderator the chance to terminate the conference, listen in on mute, record the call, or treat the call accordingly.

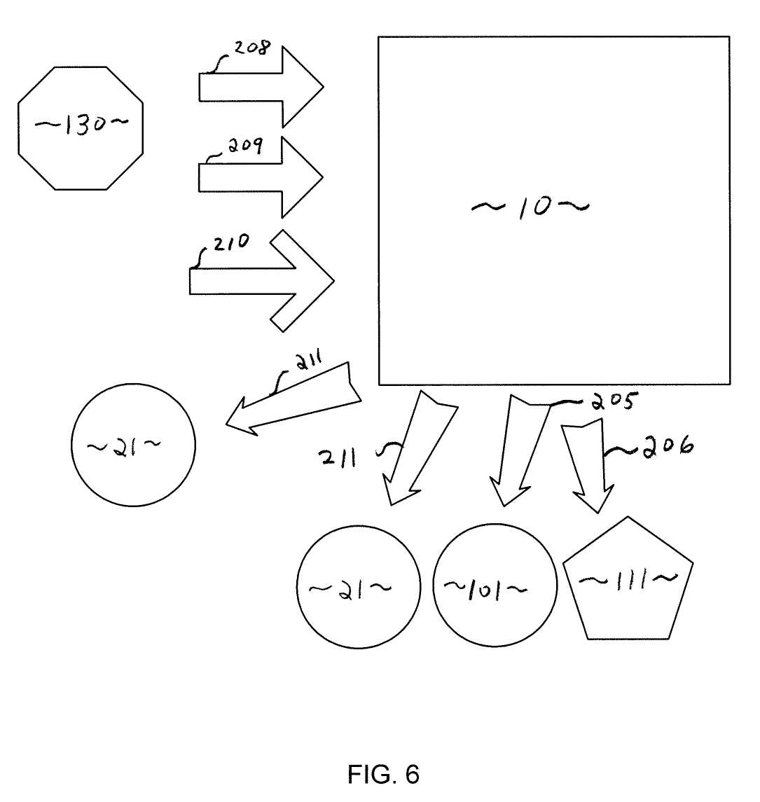

The process flow of a WAP-initiated conference is shown in FIG. 6. WAP device 130 performs a WAP login/authentication 208 to RTP Bridge 10, which may include automatic identification information 209. The call moderator enters in the destination number(s) 210 of participant(s) into the call list and clicks to call the entire list—with an option to drop or mute or drop any party. RTP Bridge 10 then dials up each number and passes through the ANI as Caller ID information, or provides a conference call reference number as an indication to the called party; or is programmed to provide no information at all, to the called parties, including cellular phones 21 via wireless network 211, analog telephones 101 via IP-PSTN 205, or directly 206 to SIP phone 111. RTP Bridge 10 then bridges all the calls to perform the on demand conference until the calls are self terminated or a predetermined time limit is reached for the duration of the call or recipients are dropped from the moderator's available options programmed in the WAP GUI.

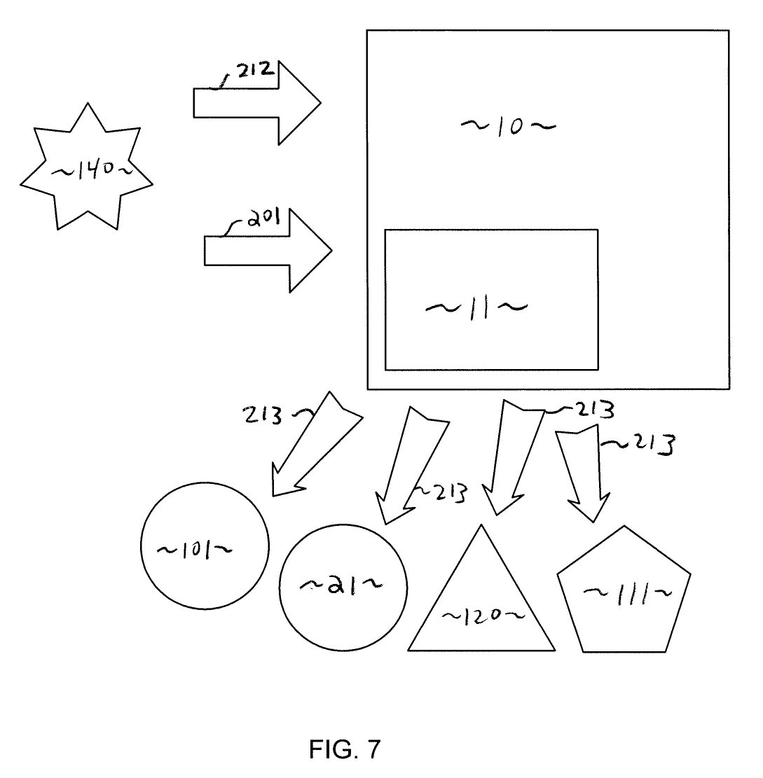

As showing in FIG. 7, an embodiment of the present invention, prior to the execution of a conference launch sequence by RTP Bridge 10, the caller using any appropriate telecommunications device 140, issues programming information 212 to RTP Bridge 10, which interprets and stores this data as a pre-programmed “launch sequence” 10. The pre-programmed information includes the destination numbers or addresses of all recipients, in the form of a call list, which may be entered via web interface, Interactive Voice Response (IVR), or voice activation system, and is assigned a PIN number by RTP Bridge 10. Next, the caller initiates launch sequence by entering the assigned PIN number 201. In response, RTP Bride 10 executes pre-programmed sequence 11, placing calls 213 based on the pre-programed information to designated phones or communications devices, including, for example, analog phone 101, cellular phone 21, SIP phone 111, or other device 120. Universal RTP bridging is employed to perform the conference until the calls are self terminated or a predetermined limit set for the duration of the call is reached.

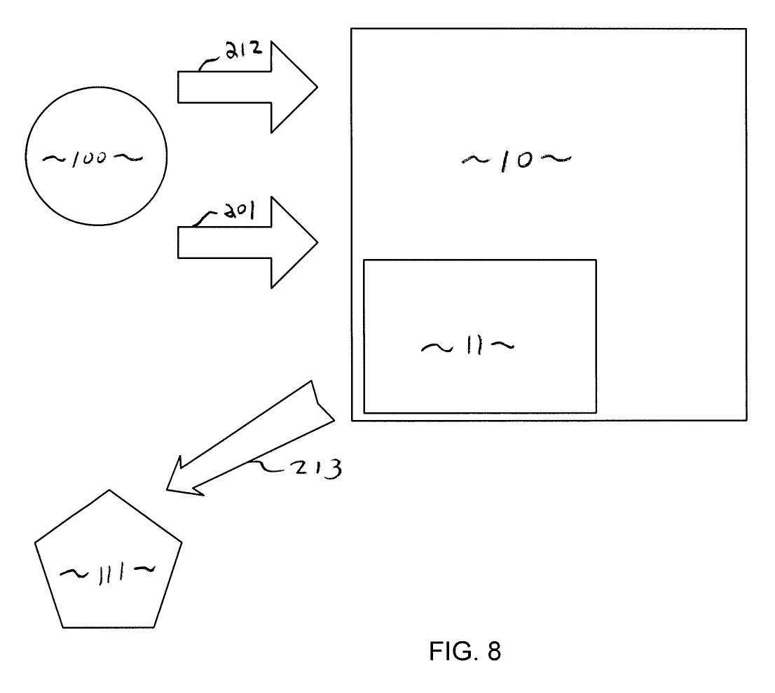

In FIG. 8, a process for allowing PSTN calls from any phone to reach SIP communication devices, wherein the apparatus launches a preconfigured set of execution steps to place calls to pre-programmed SIP number or other devices, is shown. In this embodiment, prior to the launch sequence the caller issues pre-programmed information 212, including the destination number or address in the form of a call list from a web interface, IVR, or voice activation system and is assigned a PIN number by 201 by RTB Bridge 10, which stores the entered data as pre-programmed instructions 11. Next, the caller, using, for example, analog phone 100, initiates the launch sequence by entering the previously-assigned PIN number. In response, RTP Bridge 10 executes pre-programmed instructions 11, placing calls 213 based on the pre-programmed information to reach the previously designated SIP phone number or address. In this embodiment, call 213 is placed by RTP Bridge 10 through the Use of appropriate SIP peering to reach the destination number or address, and the further use of SIP bridging to perform the conference until the calls are self terminated or a predetermined time limit set for the duration of the call is reached.

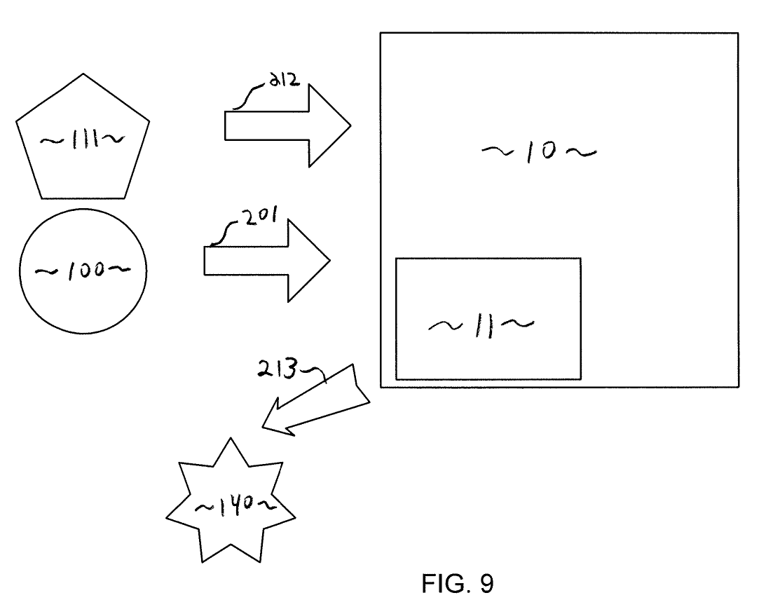

In FIG. 9, a process for allowing PSTN or SIP calls from any type of phone to reach any other RTP communication devices, wherein the apparatus launches a preconfigured set of execution steps to place calls to pre-programmed SIP number or other devices, is shown. In this embodiment, prior to the launch sequence the caller entered pre-programmed data 212, in the form of destination numbers or addresses into a call list from a web interface, IVR, or voice activation system. The information is received and interpreted by RTP Bridge 10, and is stored in the form of a set of preprogrammed instructions 11. Next, RTP Bridge 10 assigns a PIN number to the preprogrammed call. Using, for example, analog phone 100 or SIP phone 111, the caller initiates the pre-programmed launch sequence by contacting the RTP Bridge though various methods and then entering the assigned PIN number 201. In response, RTP Bridge 10 places calls 213 based on the pre-programmed information 11 to designated numbers or address of a variety of types of recipient communications devices 140. RTP Bridge 10 uses the appropriate SIP peering to reach the destination number or address and uses SIP bridging and translation to perform the conference until the calls are self terminated or a predetermined time limit is met for the duration of the call.

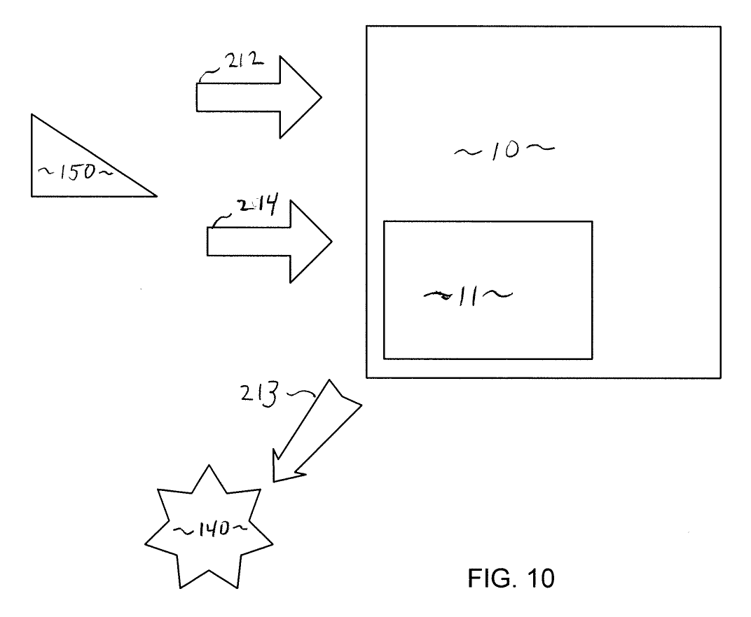

In FIG. 10, a process for signaling from any SIP device connected to the RTP Bride, wherein the apparatus launches a preconfigured set of execution steps to place pre-programmed calls, is shown. Intelligent SIP signaling device 150 may, for example, ping a specific IP in order to command RTP Bridge 10 to perform a conference launch sequence. Prior to initiating the launch sequence, the user issues a series of pre-programmed instructions 212 to RTP Bridge 10 (where they are interpreted and stored as pre-programmed instructions 11), including the destination numbers or addresses into a call list prior to the call by entering/selecting data from a web interface, IVR, or voice activation system and is recognized by it'S address or SIP number Next, the user initiates launch sequence by contacting RTP Bridge 10 though various methods such as using SIP signal 214, issued from a push-to-talk device on a cell phone. In response, RTP Bridge 10 places calls 213 to previously-identified devices 140, based on the pre-programmed information 11. RTP Bridge 10 then bridges all the calls to perform the conference until the calls are self terminated or a predetermined time limit is reached for the duration of the call.

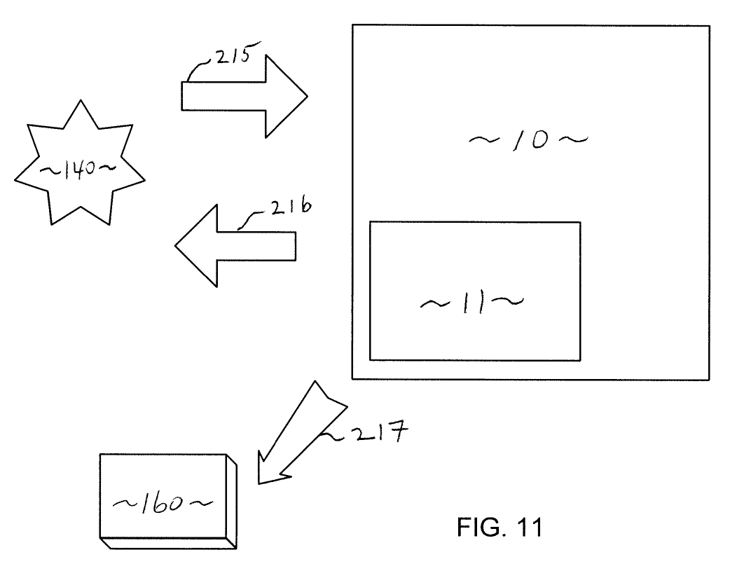

In FIG. 11, a process for bridging any SIP based speech-to-text, recording, multicasting, or streaming device into the call to receive a one way transmission or real-time translation is shown. First, the user issues a request 215 for an on demand conference call based on any of the previously-discussed methods, resulting in a pre-programmed instructions 11, or “launch sequence”, being interpreted and stored within RTP Bridge 10. Once the conference is initiated by the user, RTP Bridge, 10 places a series of calls 216. 1In addition, RTP Bridge 10 sends a translated RTP stream 217 to a selected recording or read only device 160, and bridges all the streams. In the instance of a target recording device, the recorded packets are converted to a waveform audio (WAV) type file, sent as waveform audio file and not archived on the apparatus. In the instance of a translation device, the edge translation device may send SIP packets back to RTP Bridge 10 which will be interlaced into the RTP stream and presented to participants with compatible devices.

The present Universal Real Time Protocol invention may also be employed to deliver specific and unique marketing to both calling and called parties participating in RTP bridged conference calls, utilizing either their cellular or PSTN landline services. With respect to the calling party, during the validation process when a caller dials into the Universal RTP Bridge, advertising is delivered during the authentication process when the caller ID is checked against the RADIUS server. Advertising is delivered in any of the following ways for callers initiating RTP bridging calls:

While the caller waits for their caller ID authentication, the caller listens to an audio stream advertisement. Alternatively, prior to authentication, the caller is asked to take a quick survey. Through the survey, a monitoring server captures responses based on the caller ID, then delivers specific content to the caller based on their preference of information. Alternatively, while the caller waits for their caller ID authentication, the caller listens to an audio stream advertisement, and, upon completion of the message, the server audibly prompts a response to the ad, such as “do you want to hear more about this information”, or “do not deliver messages about product ‘X’.” The server associated with the RTP Bridge then identifies further advertisements for that caller based on their preferences.

Alternatively, while the caller initiates the caller ID authentication for a cellular call, an advertisement is delivered via the audio stream, and the ad asks the caller if they want to participate in a special offer. If the caller accepts the offer, a coupon number or offering code is then text massaged to the caller for redemption for the special offer. Alternatively, while the caller initiates the authentication process from a web enabled PDA, Blackberry web/WAP phone, IP phone or IP video phone, the caller listens to an audio advertisement which provides options to participate in an online survey, additional advertisement or sponsored give away such as a limited or unlimited toll free call, which is sent to the callers IP address. Alternatively while the caller initiates the authentication process from a PSTN landline phone, the caller listens to an audio advertisement which provides options via input to the phone's keypad, or using voice recognition, to participate in an online survey, additional advertisement or sponsored give away, such as a limited or unlimited toll free call, which is sent to an IP address designated by the caller.

Through a web dashboard interface and a server associated with the RTP Bridge that delivers the ad content, callers can choose the type of products and services that they are interested in hearing about. Through the web dashboard, consumers can manipulate market themes such as sporting goods, beverage preferences, auto offerings and local, regional and national product offerings. Products can be specified by brand, category or industry. Additional advertising in the form of “On-Hold Advertising,” is likewise made available for persons receiving calls (i.e., the called parties in the conference calls established using the RTP bridge of the present invention). For example, anytime the calling party flashes over to another call waiting, while the called party is on hold, an advertisement can be looped into the audio stream from a server associated with the RTP Bridge device. The audio stream bay be either interactive or non-interactive Holding called parties can either hear the ad or elect to participate in an interactive ad at a later time or date.

The description of the various embodiments and functions of the RIP Bridge provided above is intended to be exemplary only. Furthermore, it will be understood that modifications and variations may be effected without departing from the scope of the novel concepts of the present inventions, but it is understood that this application is limited by the scope of the appended claims.

What is claimed is:

1. A telecommunications apparatus using RTP based bridging for establishing interlaced, two-way audio communications between communications devices connected to both PSTN and IP communications networks, the telecommunications apparatus comprising:
means for receiving data from at least one of a calling parties TDM phone, a calling, party's intelligent communications device, and a calling parties alternative SIP signaling device;
means for authenticating the calling party's identify using at least one of ANI, Caller ID, PIN number, IVR, IP address, or a signaling protocol;
means for recording the calling party's identity for later identification;
means for requesting the calling party to identify at least one party to be called by entry of a number or address associated with called party's telecommunications equipment;
means for placing at least one call to a local PSTN telephone number using at least one of SIP-PSTN proxy services, IP-PSTN, direct connection to a SIP telephone number, or sending RTP packets to a communications device capable of recording or converting RTP data streams to a different media type.

2. The apparatus according to claim 1, wherein the means for requesting the calling party to identify at least one party to be called by entry of a number or address associated with called party's telecommunications equipment includes means for receiving conference call launch data, comprising at least one of:
means for receiving and translating touch tone signals using Interactive Voice Response (IVR);
means for receiving HTTP data from a web browser;
means for receiving WAP data from a WAP-enabled device; and
means for receiving signaling data from a VoIP-capable device.

3. The apparatus as claimed in claim 1, wherein the RTP bridging, authentication, and pre-programmed launch sequence instructions are done by the same machine such as an appliance.

4. The apparatus according to claim 1 wherein the apparatus comprises a software application residing within at least one of a SIP Bridge, a softswitch an SIP Proxy Server, or a service creation platform separate from a high density telco switch or Media Gateway port.

5. A method for establishing a conference call between a calling party and a called party using an RTP bridge device, the method comprising the steps of:
from a calling device of the calling party, calling a predefined telephone number that terminates to the RTP bridge device;
recording an identifier of the calling device, the identifier comprising at least one of an ANI, SIP number, or IP addresser other signaling device;
authenticating the identifier against a registration database;
dropping the call received from the calling device;
dialing back the calling device;
providing instructions to the calling party via the calling device, prompting the calling party to enter at least one number corresponding to a called device of the called party in a conference call;
determining a type of communications protocol used by the called device; and
establishing a native form connection to the called device by translating the communications protocol using at least one of software codecs and hardware micro controller units into a common RTP data stream; and
passing through the identifier of the calling device to the called device as an indication to the called party to recognize an incoming request for communications.

6. The method according to claim 5, wherein the calling party acts as a first moderator for the conference call, further comprising the steps of:
dialing back a predetermined, alternative number or address corresponding to a second moderator; and
permitting the second moderator to perform at least one of terminating the conference call, listening in on the conference call, and recording the conference call.

7. The method according to claim 5, wherein the calling device is a WAP-enabled device, further comprising the step of sending the RTP bridging device a set of preprogrammed instructions for the conference call, the preprogrammed instructions including a time limit for a duration of the conference call entered using a GUI interface provided to the WAP-enabled device.

8. The method according to claim 5, further comprising the step of signaling the RTP Bridge device to executer a preprogrammed launch sequence to initiate the conference call.

9. The method according to claim 5, further comprising the step of recording at least one of audio and video data associated with the conference call.

10. The method according to claim 9, further comprising the step of duplicating the at least one of audio and video data for broadcast or multicast distribution.

11. The method according to claim 9 further comprising the step of playing backs the recorded data.

12. The method according to claim 5, further comprising the step of signaling the RTP Bridge device to capture and stream on demand, do as to simulate a push-to-talk or walkie talkie operation from any communications device participating in the conference call.

13. The method according to claim 5, wherein the step of calling the predefined telephone number that terminates to the RTP bridge device comprises using a Ring Down Circuit to signal the RTP bridge device, thereby permitting the RTP bridge device to drop the call and initiate a call back to the calling party.

14. The method according to claim 5, further comprising the step of creating a peer-to-peer connection between the calling and called devices.

15. The method according to claim 14 wherein the peer-to-peer connection uses a multicast tunnel.

16. The method according to claim 14, wherein the peer-to-peer connection uses data encryption.

17. The method according to claim 14, wherein the peer-to-peer connection carries at least one of private voice, video, or data communications.

18. The method according to claim 5, further comprising the step of delivering advertising information to at least one of the calling party and the called party.

19. The method according to claim 18, wherein the advertising information comprises audio information delivered from a server associated with the RTP bridge device.

20. The method according to claim 19, wherein the audio information is interactive audio information.
